(19) United States
(12) Patent Application Publication
(10) Pub. No.: US 2014/0265403 A1
(43) Pub. Date: Sep. 18, 2014

(54) RAMP ASSEMBLY

(71) Applicant: Kenneth J. Farber, Granville, OH (US)

(72) Inventor: Kenneth J. Farber, Granville, OH (US)

(73) Assignee: Farber Specialty Vehicles Inc., Reynoldsburg, OH (US)

(21) Appl. No.: 13/841,266

(22) Filed: Mar. 15, 2013

(51) Int. Cl. A61G 3/02; B60P 1/43

(52) U.S. Cl. CPC A61G 3/0236; B60P 1/431
USPC 296/19; 414/537

(57) ABSTRACT

A ramp assembly for installation on the rear of a transport vehicle. The ramp assembly is expandable from a stored position to an installed position. The ramp assembly includes an elongated base portion and an elongated connecting portion. A rail of one elongated side of the connecting portion is cooperatively shaped to engage at least one connector of an elongated side of the base portion.

### BACKGROUND

The transportation of supplies, patients and trained personnel is an important aspect of the medical field. In recent years, the need for transportation of patients between two locations has increased, especially in specific disciplines. For example, the federal government is a large user of medical transportation in military and veteran affairs. Exemplary transportation methods include by airplane, helicopter, truck and ambulance.

A transport vehicle has many military and veteran applications. For example, wounded military servicemen and servicewomen are often transported from an initial treatment location to a secondary area offering greater service, and generally evacuated from one location to another location. These exemplary uses and other uses of a medical transport vehicle in the military requires efficient loading, storing and unloading of patients. Patients may be loaded by litter, wheelchairs, upright seats, or by manual-assist walking. Efficiency, speed and safety concerns during loading, storage and movement may limit the number of patients which may be transported at one time.

### SUMMARY

The present application describes a ramp assembly for installation on the rear of a transport vehicle.

In an exemplary embodiment, the ramp assembly includes a base portion and a connecting portion. The base portion includes a first elongated side and a second elongated side. The connecting portion has a first elongated side and a second elongated side. The second elongated side of the connecting portion is cooperatively shaped to engage at least one connector of the second elongated side of the connecting portion.

### BRIEF DESCRIPTION OF THE DRAWINGS

Features and advantages of the general inventive concepts will become apparent from the following detailed description made with reference to the accompanying drawings.

FIG. 1 is a top view of a base portion of a ramp assembly;

FIG. 2 is a top perspective view of the base portion of FIG. 1;

FIG. 3 is a bottom perspective view of the base portion of FIG. 1;

FIG. 4 is a top perspective view of a connecting portion of a ramp assembly;

FIG. 5 is a bottom perspective view of the connecting portion of FIG. 4;

FIG. 6 is a top perspective view of a ramp assembly;

FIG. 7 is a top view of a ramp assembly, showing the base portion of FIG. 1 and the connecting portion of FIG. 4;

FIG. 8 is a bottom perspective view of the ramp assembly of FIG. 7;

FIG. 9 is a sectional view of the ramp assembly of FIG. 7 shown along the lines 9-9 of FIG. 8;

FIG. 10 is an enlarged view of the designated area of FIG. 9, showing the connecting portion attached to the base portion;

FIG. 11 is a perspective rear view of a transport vehicle, shown with a set of rear doors open and the ramp assembly of FIG. 6 in an installed position;

FIG. 12 is a side perspective view of the ramp assembly of FIG. 7, shown in a stored orientation;

FIG. 13 is enlarged rear perspective view of the transport vehicle of FIG. 11, showing an opening to a storage area and the ramp assembly of FIG. 7 in a stored orientation within the storage area; and

FIG. 14 is an enlarged rear perspective view of the transport vehicle of FIG. 11, showing a mounting bracket.

### DETAILED DESCRIPTION

This Detailed Description merely describes exemplary embodiments in accordance with the general inventive concepts and is not intended to limit the scope of the invention or the claims in any way. Indeed, the invention as described by the claims is broader than and unlimited by the exemplary embodiments set forth herein, and the terms used in the claims have their full ordinary meaning.

The general inventive concepts will now be described with occasional reference to the exemplary embodiments of the invention. This general inventive concept may, however, be embodied in different forms and should not be construed as limited to the embodiments set forth herein. Rather, these embodiments are provided so that this disclosure will be thorough and complete, and will fully convey the scope of the general inventive concepts to those skilled in the art.

Unless otherwise defined, all technical and scientific terms used herein have the same meaning as commonly understood by one of ordinary skill in the art encompassing the general inventive concepts. The terminology set forth in this detailed description is for describing particular embodiments only and is not intended to be limiting of the general inventive concepts. As used in this detailed description and the appended claims, the singular forms “a,” “an,” and “the” are intended to include the plural forms as well, unless the context clearly indicates otherwise.

Unless otherwise indicated, all numbers expressing quantities of ingredients, properties such as molecular pressure source, reaction conditions, and so forth as used in the specification and claims are to be understood as being modified in all instances by the term “about.” Accordingly, unless otherwise indicated, the numerical properties set forth in the specification and claims are approximations that may vary depending on the suitable properties sought to be obtained in embodiments of the present invention. Notwithstanding that the numerical ranges and parameters setting forth the broad scope of the general inventive concepts are approximations, the numerical values set forth in the specific examples are reported as precisely as possible. Any numerical values, however, inherently contain certain errors necessarily resulting from error found in their respective measurements.

The term litter as used in this specification refers to any hand-carried transport vehicle for one or more humans. Exemplary litters may take the form of open chairs or beds carried by two or more men, some being enclosed for protection from the elements. An exemplary medical litter may be two poles between which fabric bedding is stretched. Four men may carry a patient on such a litter by each man holding a single end of one of the two poles.

The present invention relates to a ramp assembly for installation on the rear of a transport vehicle. The ramp assembly is expendable from a stored position to an assembled position. In an exemplary embodiment, the ramp assembly includes a base portion having a top surface, a bottom surface, a first elongated side, a second elongated side, a first end and a second end. The first elongated side has a raised rail extending upward and beyond the top surface of the base portion. The second elongated side has at least one connector. The connecting portion has a top surface, a bottom surface, a first elongated side, a second elongated side, a first end and a second end. The first elongated side has a raised rail extending upward and beyond the top surface of the connector portion. The second elongated side has a raised rail extending downward and beyond the bottom surface of the connector portion. The raised rail of the second elongated side of the connecting portion is cooperatively shaped to engage the at least one connector of the second elongated side of the base portion.

In another exemplary embodiment, a transport vehicle for carrying one or more medical patients is disclosed. The transport vehicle includes a cargo area, a set of rear doors, a storage area and a ramp assembly. The cargo area has an interior space at least large enough to contain at least one medical patient carried on a litter. The storage area is disposed underneath and remote from the cargo area and has a first width. The ramp assembly has a base portion and a connecting portion. The connecting portion is attachable to the base portion when the ramp assembly is in an assembled position and has a second width, and stackable on the base portion when the ramp assembly is in a stored position and has a third width. The second width is greater than the first width, and the third width is less than the first width.

Referring now to the drawings, FIG. 1 is a top view of a base portion 10 of a ramp assembly. FIGS. 2 and 3 illustrate a top perspective view and a bottom perspective view, respectively, of the base portion 10. The exemplary base portion 10 shown is an elongated section which forms about half of a ramp assembly (see FIG. 7). The base portion has a first elongated side 12, a second elongated side 14, a first end 16 and a second end 18. The first elongated side 12 has a raised rail 20 extending upward and beyond the top surface 22 of the base portion 10. It would be obvious to one skilled in the art that the generally shape and size of the base portion 10 may change in the practice of the invention.

As shown in FIGS. 1-3, the second elongated side 14 include two saddle style connectors 30, 32. The connectors 30, 32 are secured to a elongated bar 34 on the bottom of the first elongated edge 12. Each connector 30, 32 includes an upwardly facing mating surface 30a, 30b for engagement with a connecting portion, as discussed herein, and a downwardly facing surface 32a, 32b, respectively. The downwardly facing surface 32a, 32b is generally flat and parallel with the top surface 22 of the base portion, so that the base portion 10 may conveniently rest of a flat surface, such as for example, the ground or within a storage area.

The exemplary base portion includes other advantageous features. Two mounting connectors extending outward and longitudinally from the first end 18 of the base portion 10. The exemplary connectors are hooks 40, 42 which connect to mounting brackets on the rear of a transport vehicle, as discussed herein. The connectors may be of any suitable shape, number or location in the practice of the present invention.

The base portion 10 in application may be temporarily stored in an area with access from only one end. Two wheels 50, 52 are rotatably mounted on the bottom surface and in proximity of the first end 16 on the base portion. Near the opposing second end 18 of the base portion, an aperture 44 is defines through the top surface 22 of the base portion for hand gripping by a user. As illustrated, the aperture 44 is at position closer to the second end of the base portion than the first end of the base portion. As such, a user can grip and slightly lift the base portion at the second end 18, balance the base portion on the wheels 50, 52, and pull or push the base portion 10 in a either longitudinal direction.

The base portion is shaped to promote entry and exit on foot from the second end 18. As shown in FIG. 2, the base portion 10 includes a tampered portion 54 on the top surface 22. The tampered portion 54 is adjacent and sloping downward toward the second end 18 of the base portion 10 to promote ease of foot travel on and off the top surface. One side of the tampered portion 54 is bounded by a frame 68 which extends outward to provide balance relative the ground when the opposite first end 16 is attached to a transport vehicle.

The base portion 10 is constructed to withstand the weight of at least four men carrying a litter upon which a patient is riding. The base portion may be constructed of any material of suitable strength, such as for example, stainless steel. The exemplary base portion 10 shown in FIGS. 1-3 has a top surface 22 formed of repetitive sections 60, 62, 64 and a bottom surface 66, wherein the bottom surface of the base portion defines a non-planar repetitive sinusoidal pattern. It will be obvious to one skilled in the art that other top surface and bottom surface patterns may be utilized in the practice of the present invention.

The base portion 10 is arranged to mate with a connecting portion to form a ramp assembly. When assembled with a connection portion and in an installed position relative a transport vehicle, the ramp assembly helps to provide and entrance and exit path to and from the transport vehicle.

Referring now to FIG. 4, a top perspective view of an exemplary connecting portion of a ramp assembly is shown. A bottom perspective view of the connecting portion 100 is shown in FIG. 5. The connecting portion 100 shares certain features of the base portion 10, and has certain distinct features relative the base portion 10.

The exemplary connecting portion 100 shown is an elongated section which forms about half of a ramp assembly (see FIG. 7). The connecting portion 100 has a first elongated side 112, a second elongated side 114, a first end 116 and a second end 118. The first elongated side 112 has a raised rail 120 extending upward and beyond the top surface 122 of the connecting portion 100. It would be obvious to one skilled in the art that the generally shape and size of the connecting portion 100 may change in the practice of the invention.

The connecting portion is structured to quickly and easily attach to the base portion. One or more personnel associated with a transport vehicle can assemble and install the ramp assembly to the rear of the vehicle. The ramp assembly can be assembled, and then installed to the rear of the vehicle, such as is two or more personnel are available. Alternatively, a single person can install the base portion to the rear of the vehicle, then install the connecting portion to the rear of the vehicle, and at the same time, complete the assembly of the ramp assembly.

The connecting portion is structured to quickly engage to, and quickly engage from, the ramp portion. As shown in FIG. 5, the second elongated side 114 of the connecting portion 100 has a raised rail 170 extending downward and beyond the bottom surface 166 of the connector portion 100. The raised rail 170 of the second elongated side 114 is cooperatively shaped to engage the two connectors 30, 32 of the second elongated side 14 of the base portion 10. Specifically, the raised rail 170 rests upon the two upwardly facing surfaces 30a, 32a of the two connectors 30, 32, respectively.

As shown in FIGS. 4 and 5, the exemplary connecting portion 100 includes other advantageous features. Two mounting connectors extending outward and longitudinally from the first end 118 of the connecting portion 110. The exemplary connectors are hooks 140, 142 which connect to mounting brackets on the rear of a transport vehicle, as discussed herein. The connectors may be of any suitable shape, number or location in the practice of the present invention.

The connecting portion 100 in application may be temporarily stored in an area with access from only one end. Near the second end 118 of the connecting portion, an aperture 144 is defines through the top surface 122 of the connecting portion for hand gripping by a user. As illustrated, the aperture 144 is at position closer to the second end of the connecting portion than the first end of the connecting portion. As such, a user can grip the connecting portion 100 by the aperture 144 to manipulate the position of the connecting portion 100, such as for example, to lift the connecting portion 100 out of an assembled position with the base portion 10.

The connecting portion is shaped to promote entry and exit on foot from the second end 118. As shown in FIG. 4, the connecting portion 110 includes a tampered portion 154 on the top surface 122. The tampered portion 154 is adjacent and sloping downward toward the second end 118 of the connecting portion 110 to promote ease of foot travel on and off the top surface. One side of the tampered portion 154 is bounded by a frame 168 which extends outward to provide balance relative the ground when the opposite first end 116 is attached to a transport vehicle.

The connecting portion 110 is constructed to withstand the weight of at least four men carrying a litter upon which a patient is riding. The connecting portion may be constructed of any material of suitable strength, such as for example, stainless steel. The exemplary connecting portion 100 shown in FIGS. 4 and 5 has a top surface 122 formed of repetitive sections 160, 162, 164 and a bottom surface 166, wherein the bottom surface of the connecting portion defines a non-planar repetitive sinusoidal pattern. It should be obvious to one skilled in the art that other top surface and bottom surface patterns may be utilized in the practice of the present invention.

Referring now to FIG. 6, a top perspective view of an exemplary ramp assembly 200 is shown. The ramp assembly 200 is formed by a connecting portion 210b joining a base portion 210a along an elongated center 280. The raised outer rail 220a of the base portion 210a and the raised outer rail 220b of the connecting portion 210b each extend upward a distance above the two contiguous center rails. As such, the two raised outer rails 220a, 220b provide a boundary for a person walking either direction of the ramp assembly. Entrance and exit to the ramp assembly at a second end 218a, 218b is bounded by a frame 268a, 268b. The ramp assembly 200 can be manipulated in either direction by the use of one or both of apertures 244a, 244b, each within a tapered portion 218a, 218b of the ramp assembly. The top surface 222a, 222b of the ramp assembly is defined by a repetitive pattern of apertures. The apertures may allow foreign material, such as dirt, mud, or rain, to pass through, to improve surface traction for a walker on the ramp assembly 200.

Another exemplary ramp assembly is shown in FIGS. 7-10. FIG. 7 is a top view of a ramp assembly 300 and shows the base portion 10 of FIG. 1 and the connecting portion 100 of FIG. 4. A bottom perspective view of the ramp assembly is shown in FIG. 8; In the exemplary assembly, the width W_{B} of the top surface of the base portion 10 is equal to a width W_{C} of the top surface of the connecting portion 100. A sectional view of the ramp assembly 300 shown along the lines 9-9 of FIG. 8 is shown in FIG. 8, and an enlarged view of the designated area of FIG. 9 is shown in FIG. 10, specifically showing the connecting portion 100 attached to the base portion 10. The bottom extending rail 170 of the connecting portion 100 is engaged with the top surface 30b of the connector 30.

In reference to another embodiment of the present invention, a transport vehicle includes a ramp assembly for loading and unloading patients. The patients can be moved on and off the transport vehicle by wheelchair, by litter or by manual assist. Referring to the Figures, a perspective rear view of a transport vehicle 400 is shown in FIG. 11. The transport vehicle is shown with a set of rear doors 402, 404 open and a ramp assembly 300 in an installed position. The transport vehicle includes a cargo area 406 having an interior spaced at least large enough to contain at least one medical patient carried on a litter. The set of rear doors 402, 404 offer convenient access to the cargo area 406. As best seen in FIG. 13, a storage area 410 is disposed underneath and remote from the cargo area. As discussed herein, the storage area has a first width W₁. It should be understood by those skilled in the art that the storage area may be located in alternative areas in the transport vehicle.

The transport vehicle includes a ramp assembly 300, best shown in FIG. 12. The ramp assembly has a base portion 10 and a connecting portion 100. As discussed in regard to FIG. 7, the connecting portion 100 is attachable to the base portion 10 when the ramp assembly 300 is in an assembled position, with the ramp assembly having a second width W₂. The connecting portion 100 is stackable on the base portion 10 when the ramp assembly 300 is in a stored position (see FIG. 13), with the ramp assembly having a third width W₃. As clearly illustrated in the Figures, wherein the second width W₂ is greater than the first width W₁, and the third width W₃ is less than the first width W₁. With this arrangement, the ramp assembly in a storage position can be moved into and out of the storage area 410, and a ramp assembly in an assembled position is wide enough to accommodate four personnel carrying a single litter into and out of the cargo area 406.

Referring again to FIG. 13, a plurality of mounting brackets are attached to a rear face 520 of the vehicle and below the rear doors. An enlarged rear perspective view of the transport vehicle showing a center mounting bracket is shown in FIG. 14. The mounting brackets are cooperatively shaped and numbered for attachment to the plurality of mounting brackets on the ramp assembly 300. In the exemplary embodiment illustrated, the transport vehicle 400 includes two outer mounting brackets 500, 506 and two center mounting brackets 502, 504. As shown, the center mounting brackets 502, 504 are one piece and attached to the transport vehicle 400 by hardware 510. The two center mounting brackets 502, 504 define apertures 506, 508 for hooks 40, 142 of the ramp assembly 300 to enter and attach.

While various inventive aspects, concepts and features of the general inventive concepts are described and illustrated herein in the context of various exemplary embodiments, these various aspects, concepts and features may be used in many alternative embodiments, either individually or in various combinations and sub-combinations thereof. Unless expressly excluded herein all such combinations and sub-combinations are intended to be within the scope of the general inventive concepts. Still further, while various alternative embodiments as to the various aspects, concepts and features of the inventions (such as alternative materials, structures, configurations, methods, circuits, devices and components, software, hardware, control logic, alternatives as to form, fit and function, and so on) may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the general inventive concepts even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

What is claimed is:

1. A ramp assembly for installation at the rear of a transport vehicle, the ramp assembly comprising:
a base portion having a top surface, a bottom surface, a first elongated side, a second elongated side, a first end and a second end, the first elongated side having a raised rail extending upward and beyond the top surface of the base portion, and the second elongated side having at least one connector; and
a connecting portion having a top surface, a bottom surface, a first elongated side, a second elongated side, a first end and a second end, the first elongated side having a raised rail extending upward and beyond the top surface of the connector portion, and the second elongated side having a raised rail extending downward and beyond the bottom surface of the connector portion,
wherein the raised rail of the second elongated side of the connecting portion is cooperatively shaped to engage the at least one connector of the second elongated side of the base portion.

2. The ramp assembly of claim 1, wherein the base portion includes at least one wheel rotatably mounted on the bottom surface.

3. The ramp assembly of claim 2, wherein the at least one wheel is rotatably mounted at a position closer to the first end of the base portion than the second end of the base portion.

4. The ramp assembly of claim 1, wherein the base portion includes an aperture through at least the top surface of the base portion for hand gripping by a user, the aperture at a position closer to the second end of the base portion than the first end of the base portion.

5. The ramp assembly of claim 1, wherein the base portion includes a tampered portion on the top surface, the tampered portion adjacent and sloping toward the second end of the base portion.

6. The ramp assembly of claim 1, wherein the base portion includes at least one mounting connector extending outward and longitudinally from the first end of the base portion.

7. The ramp assembly of claim 1, wherein the top surface of the base portion defines a repetitive pattern of apertures.

8. The ramp assembly of claim 1, wherein the bottom surface of the base portion defines a non-planar repetitive pattern.

9. The ramp assembly of claim 1, wherein the connecting portion includes an aperture through at least the top surface of the connecting portion for hand gripping by a user, the aperture at a position closer to the second end of the connecting portion than the first end of the connecting portion.

10. The ramp assembly of claim 1, wherein the connecting portion includes a tampered portion on the top surface, the tampered portion adjacent and sloping toward the second end of the connecting portion.

11. The ramp assembly of claim 1, wherein the connecting portion includes at least one mounting connector extending outward and longitudinally from the first end of the connecting portion.

12. The ramp assembly of claim 1, wherein the top surface of the connecting portion defines a repetitive pattern of apertures.

13. The ramp assembly of claim 1, wherein the bottom surface of the connecting portion defines a non-planar repetitive pattern.

14. The ramp assembly of claim 1, wherein a width of the top surface of the connecting portion is equal to a width of the top surface of the connecting portion.

15. The ramp assembly of claim 1, wherein the raised rail of the first elongated side of the base portion and the raised rail of the first elongated side of the second elongated side each extend upward a distance higher than either of the second elongated side of the base portion and the second elongated side of the connecting portion.

16. A transport vehicle for carrying one or more medical patients, the transport vehicle comprising:
a cargo area having an interior space at least large enough to contain at least one medical patient carried on a litter;
a set of rear doors allowing access to the cargo area;
a storage area disposed underneath and remote from the cargo area and having a first width; and
a ramp assembly having a base portion and a connecting portion, the connecting portion attachable to the base portion when the ramp assembly is in an assembled position and the ramp assembly has a second width, and stackable on the connecting portion when the ramp assembly is in a stored position and the ramp assembly has a third width;
wherein the second width is greater than the first width, and the third width is less than the first width.

17. The transport vehicle of claim 16 further comprising a plurality of mounting brackets attached to a rear face of the vehicle and below the rear doors.

18. The transport vehicle of claim 17, wherein the ramp assembly comprises a plurality of mounting connectors cooperatively shaped for attachment to the plurality of mounting brackets.

19. The transport vehicle of claim 16, wherein the ramp assembly comprises a proximal end for attachment to the vehicle and a distal end for placement on the ground.

20. The transport vehicle of claim 19, wherein the ramp assembly comprises a tampered portion adjacent and sloping toward the distal end.

21. The transport vehicle of claim 16, wherein the base portion comprises at least one wheel such that the ramp assembly may be rolled within the storage area.
